(19) United States
(12) Patent Application Publication
(10) Pub. No.: US 2011/0018357 A1
(43) Pub. Date: Jan. 27, 2011

(54) Self powered mili, micro, and nano electronic chips

(76) Inventors: Eric Jay, Rigby, ID (US); Rex Dale Yarger, Brigham City, UT (US); Eric John Yarger, Rigby, ID (US)

Correspondence Address: ERIC JOHN YARGER, 3811 EAST 214 NORTH, RIGBY, ID, 83442, US

(21) Appl. No.: 12/804,330

(22) Filed: Jul. 20, 2010

Related U.S. Application Data
(60) Provisional application No. 61/271,659, filed on Jul. 24, 2009.

(51) Int. Cl. H02J 17/00

(52) U.S. Cl. 307/104; 977/742; 977/894

(57) ABSTRACT

Self powered mico, mili, and nano electronic chips having one or more methods of self-power production. Comprising a series of carbon nanotubes with attached magnetic bacteria for creating vibration with the existing Radio Frequency (RF) fields of the oscillators included in the electronic device or ambient RF fields across coils. As well as a layer of Ni—Mn—Ga magnetoplastic layer which is deformed by magnetic flux lines to cause current flow thorough coils of wire. This configuration creates a power generator on the chipset comprising of magnetic fields and a coil configured to focus the magnetic field in the electrical conductive elements of the coil.

### U.S. PATENT DOCUMENTS

| | | | |
|---|---|---|---|
| 4,385,119 A | May 1983 | Blakemore | 435/1683 |
| 4,394,451 A | July 1983 | Blakemore | 435/253.6 |
| 4,452,896 A | June 1984 | Blakemore | 435/252.1 |
| 5,590,031 A | December 1996 | Mead | 363/8 |
| 5,703,474 A | December 1997 | Smalser | 323/299 |
| 6,766,141 A | July 2004 | Briles | 455/40 |
| 6,818,470 A | November 2004 | Acklin | 438/55 |
| 7,084,605 A | August 2006 | Mickle | 320/101 |
| 7,514,804 A | April 2009 | Wang | 290/1R |
| 7,567,824 A | July 2009 | Mickle | 455/573 |
| 7,749,727 A | July 2010 | Sheppard | 435/29 |

### FOREIGN PATENT DOCUMENTS

| | | | |
|---|---|---|---|
| 7,161,245 A | January 2007 | Saito | 257/737 |

### OTHER PUBLICATIONS

None cited

### STATEMENT REGARDING GOVERNMENT INTEREST

This invention was not made under any United States Government Contract. Therefore the United States Government has no rights in the invention.

### BACKGROUND OF THE INVENTION

1. Field of the Invention

This disclosure generally relates to a system and methods for developing electronic micro, mili, and nano chips that will harvest electrical signals, converting energy into an electrical current and storing the energy from electronics signals for use in powering each individual electronic chipset.

2. Description of the Related Art

Conventional electronic devices use power provided by storage devices such as batteries, or storage capacitors. These storage devices are limited to the amount of portable energy stored in the device available to the user. Carrying additional storage media is expensive, and the user must accommodate for the weight, storage space, and the disposal aspect of the additional devices. These storage devices are environmentally unfriendly and require additional costs for proper disposal methods.

Conventional shake devices similar to the shaker flashlight provide very limited amounts of storage energy which is determined by the amount of movement of the device, and adds extra weight to electronic devices. These types of self producing power devices require physical movement of the device and relative to a high frequency Radio Frequency (RF) vibration are very inefficient.

Conventional crank-powered devices have much more energy generation capabilities than the shaker activated devices, but are bulky, require physical activity, are very noisy, and are not readily deployable to power other devices.

Similarly, electro-magnetic and electro-mechanical devices and applications such as alternators, motors, and generators require large footprints, heavy portability, and massive amounts of magnetic fields generated by the magnets and the electromotive (EMF) forces. These forces are detrimental to many portable electronic devices and to personnel.

With electro-magnetic and electro-mechanical devices desired increases in power output or performance require increasing the number of coil wires and or the number and strength of the magnetic fields. These approaches required introduction of weight, cost, and desirability issues. Standard RF harvesting devices are very costly and inefficient due to associated electronics involved. The harvesting techniques are generally very poor, and are tuned to harvest at only one specific energy frequency efficiently. They do not create energy; they can only slightly harvest the energy of the RF field.

### BRIEF SUMMARY OF THE INVENTION

In one embodiment, a silicone chipset comprising a silicone covering layer around the chipset. In one embodiment, a layer of radio frequency electronics etched onto the layer under the top layer of the silicone chipset. In one embodiment, a layer comprising a coil of a electrical conductive winding configured to resonate at several frequencies and deposited on the chipset. In one embodiment, a coil winding set into a mesh which will resonate at differing RF frequencies and deposited on the chipset. In one embodiment, coil standoffs etched into the chipset which the coil mesh is attached. In one embodiment, a vibrational transfer plate material used to collect the RF signals and deposited onto the chipset. In one embodiment, electrically conductive coil windings configured around a magnetic source used to generate voltage. In one embodiment, carbon nanotubes which vibrate at fixed RF frequencies which have affixed magnetic bacteria which will oscillate above or below the conductive coil windings. In one embodiment, carbon nanotubes which vibrate at varying RF frequencies which have affixed magnetic bacteria which will oscillate above or below the conductive coil windings In one embodiment, electrically conductive coil mesh used to collect the voltage generated when the carbon nanotubes resonate at varying frequencies. In one embodiment, a vibrational transfer plate used for harvesting the movement of the carbon nanotubes with RF activation. In one embodiment a crystal oscillator deposited on the chipset used to tune and magnify the RF frequencies. In one embodiment, a layer of ultra pure mica is deposited onto the chip substrate. In one embodiment a layer of dense packed carbon nanotube storage material is deposited onto the chip substrate. In one embodiment a layer of chip function electronics etched into the substrate and deposited to have direct electrical interface with the dense pack carbon nanotube storage material.

In one embodiment, a silicone chipset comprising a silicone covering layer around the chipset. In one embodiment, a layer of radio frequency electronics etched onto the layer under the top layer of the silicone chipset. In one embodiment, layer comprising a coil of a electrical conductive winding configured to resonate at several frequencies and deposited on the chipset.

In one embodiment, coil winding set into a mesh which will resonate at differing RF frequencies and deposited on the chipset. In one embodiment, coil standoffs etched into the chipset which the coil mesh is attached. In one embodiment, vibrational transfer plate material used to collect the RF signals and deposited onto the chipset. In one embodiment, electrically conductive coil windings configured around a magnetic source used to generate voltage. In one embodiment, carbon nanotubes which vibrate at fixed RF frequencies which have affixed magnetic bacteria which will oscillate above or below the conductive coil windings. In one embodiment, carbon nanotubes which vibrate at varying RF frequencies which have affixed magnetic bacteria which will oscillate above or below the conductive coil windings In one embodiment, electrically conductive coil mesh used to collect the voltage generated when the carbon nanotubes resonate at varying frequencies. In one embodiment a vibrational transfer plate used for harvesting the movement of the carbon nanotubes with RF activation. In one embodiment a crystal oscillator deposited on the chipset used to tune and magnify the RF frequencies. In one embodiment, a layer of Ni—Mn—Ga magnetoplastic material deposited with the carbon nanotube which have affixed magnetic bacteria which oscillate above or below the Ni—Mn—Ga magnetoplastic material. In one embodiment, a layer of ultra pure mica is deposited onto the chip substrate. In one embodiment a layer of dense packed carbon nanotube storage material is deposited onto the chip substrate. In one embodiment a layer of chip function electronics etched into the substrate and deposited to have direct electrical interface with the dense pack carbon nanotube storage material.

In one embodiment, a silicone chipset comprising a silicone covering layer around the chipset. In one embodiment, a layer of radio frequency electronics etched onto the layer under the top layer of the silicone chipset. In one embodiment, layer comprising a coil of a electrical conductive winding configured to resonate at several frequencies and deposited on the chipset. In one embodiment, coil winding set into a mesh which will resonate at differing RF frequencies and deposited on the chipset. In one embodiment, coil standoffs etched into the chipset which the coil mesh is attached. In one embodiment, vibrational transfer plate material used to collect the RF signals and deposited onto the chipset. In one embodiment, electrically conductive coil windings configured around a magnetic source used to generate voltage. In one embodiment, carbon nanotubes which vibrate at fixed RF frequencies which have affixed magnetic bacteria which will oscillate above or below the conductive coil windings. In one embodiment a vibrational transfer plate used for harvesting the movement of the carbon nanotubes with RF activation. In one embodiment a crystal oscillator deposited on the chipset used to tune and magnify the RF frequencies. In one embodiment, a layer of Ni—Mn—Ga magnetoplastic material deposited with the carbon nanotube which have affixed magnetic bacteria which oscillate above or below the Ni—Mn—Ga magnetoplastic material. In one embodiment, a layer of ultra pure mica is deposited onto the chip substrate. In one embodiment a layer of dense packed carbon nanotube storage material is deposited onto the chip substrate. In one embodiment a layer of chip function electronics etched into the substrate and deposited to have direct electrical interface with the dense pack carbon nanotube storage material.

In one embodiment, a silicone chipset comprising a silicone covering layer around the chipset. In one embodiment, a layer of radio frequency electronics etched onto the layer under the top layer of the silicone chipset. In one embodiment, layer comprising a coil of electrical conductive winding configured to resonate at several frequencies and deposited on the chipset. In one embodiment, coil winding set into a mesh which will resonate at differing RF frequencies and deposited on the chipset. In one embodiment, coil standoffs etched into the chipset which the coil mesh is attached. In one embodiment, vibrational transfer plate material used to collect the RF signals and deposited onto the chipset. In one embodiment, electrically conductive coil windings configured around a magnetic source used to generate voltage. In one embodiment, carbon nanotubes which vibrate at fixed RF frequencies which have affixed magnetic bacteria which will oscillate above or below the conductive coil windings. In one embodiment a vibrational transfer plate used for harvesting the movement of the carbon nanotubes with RF activation. In one embodiment a crystal oscillator deposited on the chipset used to tune and magnify the RF frequencies. In one embodiment, a layer of Ni—Mn—Ga magnetoplastic material deposited with the carbon nanotube which have affixed magnetic bacteria which oscillate above or below the Ni—Mn—Ga magnetoplastic material. In one embodiment, a layer of ultra pure mica is deposited onto the chip substrate. In one embodiment, a layer of ultra pure mica is deposited onto the chip substrate. In one embodiment a layer of BLNT storage material is deposited onto the chip substrate. In one embodiment a layer of chip function electronics etched into the substrate and deposited to have direct electrical interface with the dense pack carbon nanotube storage material.

In one embodiment, a silicone chipset comprising a silicone covering layer around the chipset. In one embodiment, a layer of radio frequency electronics etched onto the layer under the top layer of the silicone chipset. In one embodiment, layer comprising a coil of a electrical conductive winding configured to resonate at several frequencies and deposited on the chipset. In one embodiment, vibrational transfer plate material used to collect the RF signals and deposited onto the chipset. In one embodiment, electrically conductive coil windings configured around a magnetic source used to generate voltage. In one embodiment, carbon nanotubes which vibrate at fixed RF frequencies which have affixed magnetic bacteria which will oscillate above or below the conductive coil windings. In one embodiment, carbon nanotubes which vibrate at varying RF frequencies which have affixed magnetic bacteria which will oscillate above or below the conductive coil windings. In one embodiment, electrically conductive coil mesh used to collect the voltage generated when the carbon nanotubes resonate at varying frequencies. In one embodiment a vibrational transfer plate used for harvesting the movement of the carbon nanotubes with RF activation. In one embodiment a crystal oscillator deposited on the chipset used to tune and magnify the RF frequencies. In one embodiment, a layer of ultra pure mica is deposited onto the chip substrate. In one embodiment a layer of dense packed carbon nanotube storage material is deposited onto the chip substrate. In one embodiment a layer of chip function electronics etched into the substrate and deposited to have direct electrical interface with the dense pack carbon nanotube storage material

### BRIEF DESCRIPTION OF THE VIEWS OF THE DRAWINGS

The patent or application file contains at least one drawing executed in color. Copies of the patent and/or the patent application publication with its color drawings will be provided by the inventor upon request and payment of the necessary fee.

FIG. 1 is a diametric cross-sectional view of the self powered electronic chip with electrical storage capabilities.

FIG. 2 is a side view of an embodiment of the nanotubes capabilities of vibrating between two coils.

FIG. 3 is a diagrammatical front view of the nano Generator for Self-Powered Electronics which shows one of the methods of providing power generation capabilities using the carbon nanotubes with the magnetosperilla attached to the nanotubes. The nanotube is then coupled with a crystal oscillator, which causes the nanotubes to vibrate as the RF fields strike the crystal oscillator.

FIG. 4 is a diagrammatical front view of multiple carbon nanotubes, which have been layered with magnetic bacteria located between two coil structures and of varying lengths. The varying lengths facilitate using multiple frequencies or different harmonics of the same frequency to cause the nanotube structures to vibrate between the coils. In this manner several frequencies along with all applicable harmonics of the frequencies can be targeted to generate power.

FIG. 5 is a block diagram of the way the carbon nanotube generators work.

FIG. 6 is a is a side view of an embodiment of the nanotubes capabilities of vibrating between two Ni—Mn—Ga magnetoplastic layers.

### DETAILED DESCRIPTION OF THE INVENTION

In the following description, certain details are set forth in order to provide a thorough understanding of the various embodiments of devices, methods, and articles. However, one skilled in the art will understand that other embodiments may be practiced without these details. In other instances, well known structures and methods associated with coils and magnetic assemblies have not been shown or described in detail to avoid unnecessary obscuring descriptions of the embodiments.

Unless the content requires otherwise, throughout the specifications and claims which follow, the word “comprise” and variations thereof such as “comprising” and “comprises” are to be constructed in an open, inclusive sense, that is as “including, but not limited to.”

References throughout this specification to “one embodiment,” or “an embodiment” means that a particular feature, structure or characteristic described in connection with the embodiment is included in at least one embodiment. Thus, the appearances of the phrases to “one embodiment,” or “an embodiment” in various places throughout this specification are not necessarily referring to the same embodiment, or to all embodiments. Furthermore, the particular features, structures, or characteristics may be combined to obtain further embodiments.

These chipsets will produce micro-scaled nano-scaled power generation systems with energy harvesting capability for application in micro and nano-electronic based devices, components, electronic chips, and systems. In any application, military or commercial, self-contained power generation will help minimize battery size, provide improved energy efficiency for electronics and could potentially supply all the required power for certain chip applications such as sensors, single chip electronic devices and complex electronic devices such as cell phones and other portable electronic devices. This technology offers solutions to current chip technologies, which are limited by the following obstacles:
Batteries need to be constantly monitored and replaced often
Slow electronic speed for power transfer
No recharge capability for nano or MEMS devices
Batteries create a large amount of hazardous waste that is difficult to recycle.

The new chipset will create self powering electronic chip technology for micro-scale power generation and eventually nano sized electronic devices and chips. The potential benefit of this platform will be integration with both system and semiconductor design. This will lead to increased energy efficiency and more compact electronic devices while reducing cost. For certain applications such as sensors, the technology may be able to keep them powered indefinitely.

Electronic devices are decreasing in size while performing increasingly complex and diverse functions. This complexity requires larger power sources. Current battery technologies are advancing, but the utilization of self powering, self generating micro, mili, and nanotechnologies will prove to be a revolution in all levels of efficiency and regenerative utilization for the majority of electronic devices' power sources regardless of size and will eventually eliminate the need for batteries.

This technology is based on Faraday's law, which states any change in the magnetic environment of a coil or wire will cause a voltage to be induced in the coil. Our innovation uses focused magnetic fields to generate the force necessary to recharge the chip. The focused magnetic field is created by compressing magnetic fields and arranging the material in configurations where compressed fields can be achieved. The opposing poles create a focused magnetic effect across the copper mesh coil and crystal structure in a localized area. This focused magnetic effect will be used with copper mesh coils designed to resonate at the same frequency that exists within the electronic devices operating Radio Frequencies (RF). This resonance will provide coil movement within the area influenced by the focused magnetic field. The generated power is transferred unidirectionally through an ultra-pure mica substrate to a storage layer located on the chip, such as and most likely a carbon nanotube storage media, The power generated by the magnetic media and the coil media will interface with the nano-chip electronics and provide power to the chip through energy harvesting of the RF signals developed by the devices clock or ambient RF waves generated by man-made signals, such as radio transmissions, found in our world today. This energy harvesting technique will allow for power to be generated by the chip and will not require battery power for its operation.

There are two methods for generating power on this proposed chip system. Both methods may be used or only one method may be used. This will be determined by industry and users.

The first method is by using a Ni—Mn—Ga magnetoplastic layer which is deformed by magnetic flux lines to cause current flow thorough coils of wire.

The role of the Ni—Mn—Ga magnetoplastic layer is to displace the coil in the compressed magnetic field. The magnetoplastic layer is actuated through a magnetic field being applied externally.

The response of magnetic shape-memory alloys to a variable magnetic field strongly depends on the crystallographic orientation of the crystals. For thin film applications, a (100) texture is required for a significant effect. Ni—Mn—Ga films grow naturally in a (110) texture on most substrates. By managing different energy contributions (strain energy vs. surface energy), it is possible to drastically change texture of thin films [8].

When a magnetic shape-memory alloy expands (or shrinks) by 10% in one direction, it also shrinks (or expands) by the same amount in an orthogonal direction. The constraints of a film deposited on a substrate (or a magnetic shape-memory layer as part of a multilayer) would suppress the cross-contraction (cross-expansion) and thus it would suppress the entire effect. Therefore, films must be patterned in nano-columns.

The magnetoplastic effect is sensitive to composition, structure, and training. The nano-structured films (or arrays with nano-columns) will be suitably trained and tested. The constraints films and small length scale need to be addressed since these affect phase transformation and small scale mechanics. All films will be carried out with ‘isolated’ Ni—Mn—Ga films. For the finally ‘assembled’ device, Ni—Mn—Ga films need to be integrated in a multilayer package. The processes for texturing, patterning, and training will be adjusted to the overall processing steps of the device.

The second method used to generate power on the self powered electronic chipset is created by using magnetic bacteria attached to carbon nanotubes which have been tuned to vibrate at several different RF frequencies. This is a unique method for magnifying the RF coil harvesting techniques that are currently employed in state-of-the-art RF harvesting.

Mili, Micro and Nano scale power generation is a completely self-contained system on a chip (Self Powered electronics). The system includes a rechargeable substrate located on the chip providing direct microelectronics interface. The chip incorporates a self-charging circuit and power management system, as well as power storage media for use in powering the chipset when no ambient or generated fields are detected. The versatility of micro- and nano-electronics is greatly enhanced by the self-charging characteristics of the system.

The magnetic effect using magnetic bacteria will be implemented with copper mesh coils designed to resonate at the same frequency that exists within the electronic devices operating Radio Frequencies (RF). This resonance will provide coil movement within the area influenced by the magnetic field. Along with another method for providing the magnetic field variation or vibration will employ a method of applying the magnetic bacteria to carbon nanotubes, or other materials such as quartz crystals, mica crystals, stainless steel spring wire, or carbon steel spring wire, that have been grown to resonate at the CPU's (Central Processor Unit) resonance as well as ambient RF waves. This will provide for a single or double power generation capability on a single chip. The generated power from both sources is then transferred unidirectionally through an ultra-pure mica substrate to a storage layer located on the chip. Which will store the harvested energy for use of the chip and for other chips as well.

The power generated by the magnetic media and the coil media will interface with the nano-chip electronics and provide power to the chip through energy harvesting of the RF signals developed by the devices clock or ambient RF waves generated by man-made signals such as radio transmissions, found in our world today. This energy harvesting technique will allow for power to be generated by the chip itself and will not require battery power for its operation.

The technology is scalable to the mili/micro/and nano level chips by creating nano scaled harvesting techniques that take advantage of magnetic structures that have been developed using magnetic bacteria called magnetosperilla, and a combination of coils used for RF field power harvesting.

By using magnetotactic bacteria, first discovered in 1975, nano-sized magnetic structures can be created to enhance the gathering of energy by RF harvesting. Magnetotactic bacteria are gram-negative aquatic prokaryotes aligning themselves with the earth's magnetic field by use of magnetosomes. Magnetosome, which are organelles containing magnetite or greigite crystals, align themselves with the earth's magnetic fields.

Each crystal is enclosed in a lipid bilayer membrane, forming chains up to 60 magnetosomes long. These crystals are attached to each other at the membrane. When the membrane of the magnetosome is lysed, the magnetite crystals agglomerate rather than staying in chain form. Aligning the magnetosome membrane provides for deposition of the cell sized magnetic structures that will be used for harvesting power.

The purified chains of magnetosomes will be isolated from the bacteria cells by use of magnetic separation techniques. The magnetic chain's coercivity is dependent on the shape, size, and orientation of the magnetosome crystal; If the crystal is less than 30 nm in diameter, it exhibits super paramagnetic properties. When the crystal becomes larger than 100 nm in diameter, it displays multiple magnetic domains. Ideally, the crystal will be between 30-100 nm in diameter and as long as possible.

The magnetic bacteria is one layer of the new chip design that allows for energy harvesting using the devices' natural RF clock speed when attached to carbon nanotubes that resonate with the device clock or through ambient RF field excitation.

Each layer of the new chip design is a preferred layer. The layers can be arranged in other orders, or replaced with similar materials or in differing configuration. The use of RF harvesting using the magnetic bacteria, and the use of RF harvesting using RF coil and magnetoplastic material harvesting techniques provides for two methods of power harvesting from the chip. The new chip design also includes a storage media that will be used to store that harvested energy when the need for the chips actual electrical need is exceeded thus providing for a storage capability to be used by other electronics or by high use times of the existing self-powering chip.

The designed chipset can operate with one power generation activity or with two. The first being the carbon nano-tubes with attached magnetosomes which will vibrate at determined frequencies or at random RF frequencies.

There are several unique layers to the chip construction. Not all layers that are on the current design need to be incorporated onto the design since it has two power harvesting functions, but the preferred method of design is for two harvesting techniques.

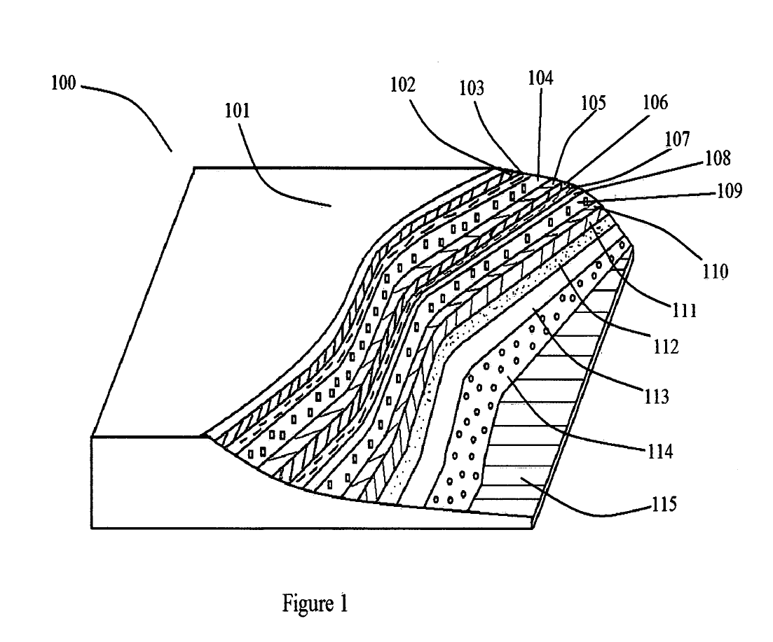

FIG. 1 is a diametric cross-sectional view of a silicone chipset 100 comprising a silicone covering layer around the chipset 101 a layer of radio frequency electronics 102 etched onto the layer under the top layer 101 of the silicone chipset. A layer comprising a coil of a electrical conductive winding 103 configured to resonate at several frequencies and deposited on the chipset. A coil winding set into a mesh which will resonate at differing RF frequencies 104 and deposited on the chipset. A set of silicone coil standoffs etched into the chipset 105 which the coil mesh is attached to. A vibrational transfer plate material 106 used to collect the RF signals and deposited onto the chipset 100. An electrically conductive coil windings configured 101 around a magnetic source 107 used to generate voltage. Carbon nanotubes 106 which vibrate at fixed RF frequencies which have affixed magnetic bacteria 107 which will oscillate above or below the conductive coil windings 101. Carbon nanotubes 106 which vibrate at varying RF frequencies which have affixed magnetic bacteria 107 which will oscillate above or below the conductive coil windings 102. An electrically conductive coil mesh 108 used to collect the voltage generated when the carbon nanotubes 106 resonate at varying frequencies. A vibrational transfer plate 109 used for harvesting the movement of the carbon nanotubes 106 with RF activation. A crystal oscillator 110 deposited on the chipset 100 used to tune and magnify the RF frequencies. A layer of Ni—Mn—Ga magnetoplastic crystal 111 A layer of Bismuth Lanthanum Neodymium Titunate (BLNT) 112 used to augment the storage capability of the dense packed carbon nanotube storage material 114 A layer of ultra pure mica 113 which is deposited onto the chip substrate 100. A layer of dense packed carbon nanotube storage material 114 is deposited onto the chip substrate 100. A layer of chip function electronics 115 etched into the chip substrate material 100 and deposited to have direct electrical interface with the dense pack carbon nanotube storage material 115.

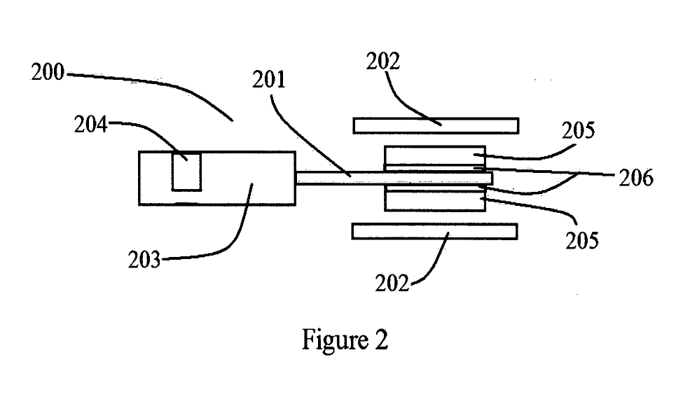

FIG. 2 is a side view of the nanotube structure 200 and the capabilities of the nanotubes 201 vibrating between two coil assemblies 202. The carbon base material 203 provides the base for the carbon nanotube 201 structure. Within the carbon nanotube base 203 is a crystal oscillator 204 Attached to the carbon nanotubes 201 is magnetic bacteria 205. The magnetic bacteria 205 is attached to the carbon nanotubes 201 by electro-chemical protein bonding solutions 206.

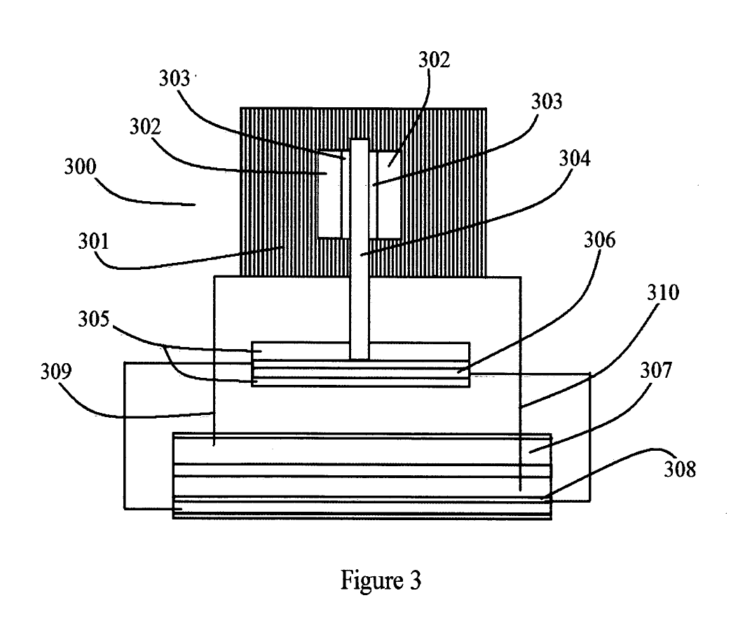

FIG. 3 is a diagrammatical front view of the nano Generator for Self-Powered Electronics 300. A micro coil of electrically conductive wire 301 is placed above and/or below the carbon nanotube 304 on which the magnetic bacteria 302 has been attached. The magnetic bacteria, 302 have been attached to the carbon nanotube 304 by use of a bonding agent 303. As the tuned carbon nanotube 304, with the magnetic bacteria 302, vibrates in resonance with the RF signals received by the carbon nanotube 304 and the crystal oscillator 306, which is installed in the carbon base material 305, it moves across the micro coil 301 voltage is generated. The voltage generated by the micro coil 301 is transferred to the carbon nanotube power storage media 307 via the negative coil connector 309 and the positive coil connector 310 to the power bus connectors 308. The power generated is stored in the carbon nanotube power storage media 307 until it is used by the electronics designed on the chip.

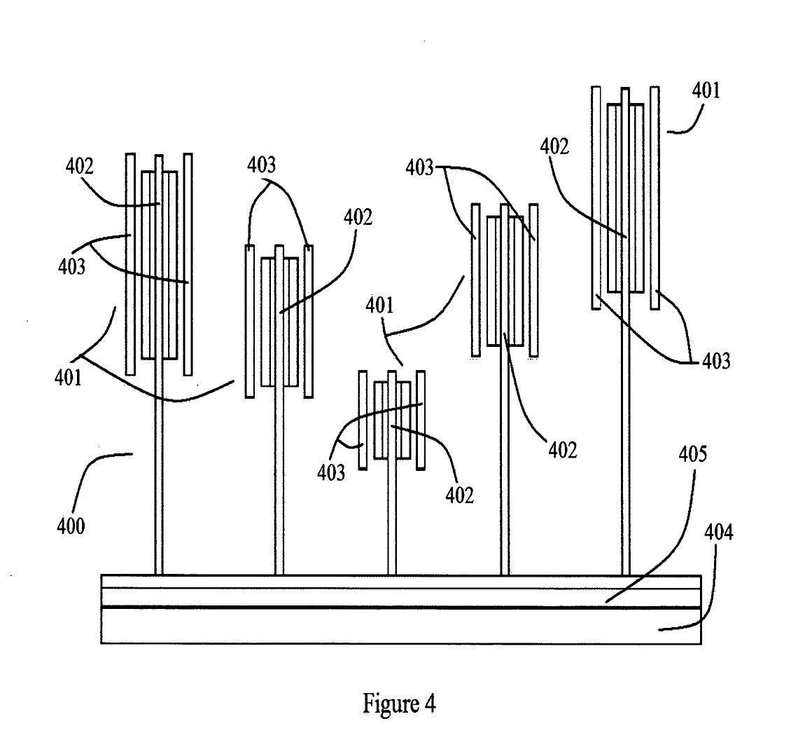

FIG. 4 is a diagrammatical front view 400 of multiple carbon nanotubes generators, 401 which have been layered with magnetic bacteria 402 located between two coil structures 403 of varying lengths. The carbon nanotubes 401 are grown form the carbon nanotube base media 404. Each nanotube 401 have been tuned to differing RF frequencies by varying the size and/or thickness of the nanotube 401 itself. The array of nanotubes receive vibrational stimulation from RF waves generated from the electronic devices clock or ambient RF waves. The crystal oscillator 405 inserted into the nanotube base media 404 attracts RF fields which are then transferred into the nanotubes 401 causing them to vibrate and create voltage across the coil structures 403.

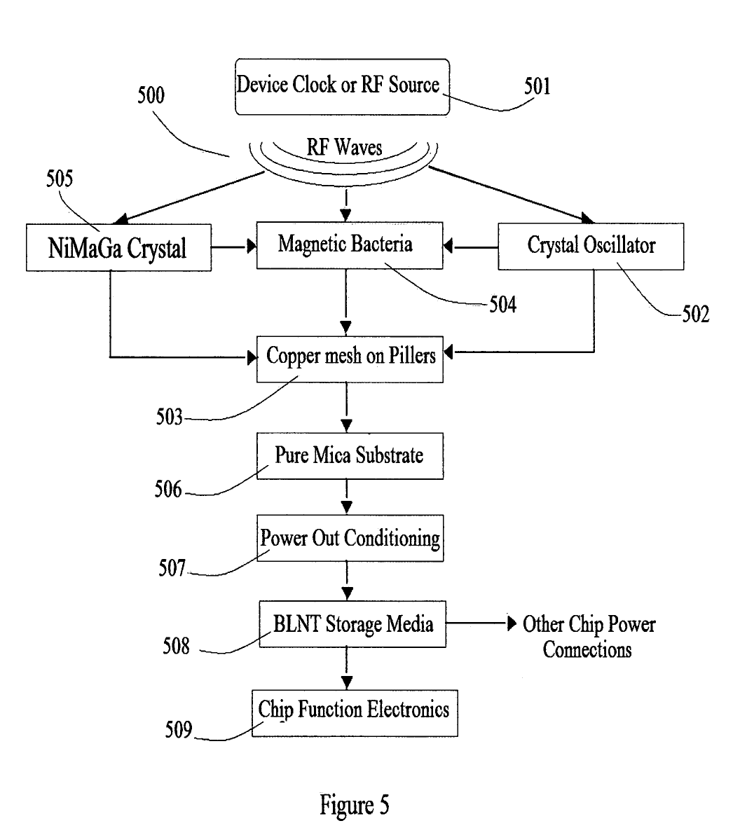

FIG. 5 is a block diagram of the way the carbon nanotube generators work. The block diagram 500 defines one way the nanotubes generate power. In block 501 the electronic device itself generates RF frequencies or ambient RF frequencies are received to the crystal oscillator 502 the copper mesh on silicone pillars 503, the carbon nanotubes 504 with the magnetic bacteria attached and the Ni—Mn—Ga magnetoplastic 505 crystal. The vibration set into motion in the copper mesh 503, and/or the carbon nanotubes causes a voltage to be generated. This voltage is passed through a high purity mica substrate 506 which allows voltage to flow into the BLNT storage media 507. The power generated by the nano generators is then stored in the BLNT storage media507. When power is required to operate the onboard electronics etched into the chipset, the power flows from the BLNT storage media to the power conditioning electronics 508 etched into the chipset. The output of the power conditioning electronics 508 is then transferred to the chip function electronics 509 and/or other chipsets.

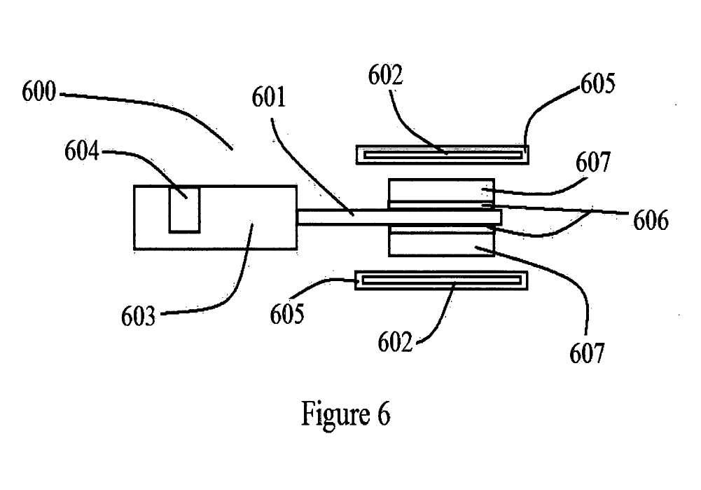

FIG. 6 is a side view of the nanotube structure 600 and the capabilities of the nanotubes 601 vibrating between two Ni—Mn—Ga magnetoplastic crystal assemblies 602. The carbon base material 603 provides the base for the carbon nanotube 601 structure. Within the carbon nanotube base 603 is a crystal oscillator 604 Attached to the carbon nanotubes 601 is magnetic bacteria 205. The magnetic bacteria 605 is attached to the carbon nanotubes 601 by electro-chemical protein bonding solutions 606.

### A. PRIOR ART

The constant drain of power on electronic devices to keep electronic chips powered will be eliminated by continual power generation built directly on the chipset. There is no prior art developments using magnetic bacteria for this type of power generation.

### B. ADVANTAGES

The benefits of the proposed technology are numerous. The modifications of self-powered electronics, which will change battery function technology and composition, will increase power source efficiency substantially for both small (cellular phones, laptops, sensors) and large (generators, automotive batteries) applications. In any application, military or commercial, self-contained power generation will help minimize battery size, or eliminate the need for batteries, and provide improved energy efficiency for electronics which could potentially supply all the required power for certain chip applications such as sensors, single chip electronic devices and complex electronic devices such as cell phones and other portable electronic devices.

What is claimed:

1. A self charging self-storage electronic chipset that produces its own power through Radio Frequency (RF) power harvesting that includes, but is not limited to, one electrical conductive coil wire over which a carbon nanotube with magnetic bacteria have been attached which will resonate in the presence of RF fields causing voltage and current to be generated in the electrical conductive coil wire with said power being stored on a layer of carbon nanotube storage media, which will be used to power the chip and or other chips.

2. A chipset as set forth in claim 1 which includes, but is not limited to, multiple lengths of carbon nanotube generators with attached magnetosomes used to take advantage of multiple frequencies

3. An electronic chipset as set forth in claim 1 which includes, but is not limited to, multiple thickness carbon nanotubes with attached magnetosomes used to take advantage of multiple frequencies.

4. An electronic chipset as set forth in claim 1 which uses any type of resonating material which will vibrate at specific frequencies. The material could include but not limited to quartz crystals, mica crystals, stainless steel spring wire, or carbon steel spring wire with attached magnetosomes magnets.

5. An electronic chipset as set forth in claim 1 that contains a storage layer to include, but is not limited to, carbon nanotubes used to store the power generated by the RF field

6. An electronic chipset as set forth in claim 1 that contains a storage layer to include, but is not limited to, Bismuth Lanthanum Neodymium Titunate (BLNT) used to store the power generated by the RF field

7. An electronic chipset as set forth in claim 1 that includes internal connections from the storage media described in claim 2 that provides for power generated by the chip to be used for the designed electronics on the chip and used to connect the power generated by the chip to the storage media

8. An electronic chip set as set forth in claim 1 that includes external connections from the generation scheme that can be connected to the storage media set forth in claim 2 or to, but not limited to, other external chips or devices that require power for operation

9. An electronic chipset as set forth in claim 1 that uses a crystal oscillator layer used to cause vibration to occur in the carbon nanotubes with the attached magnetic bacteria

10. An electronic chipset as set forth in claim 1 that uses an electronic oscillator layer used to cause vibration to occur in the carbon nanotubes with the attached magnetic bacteria

11. An electronic chipset as set forth in claim 1 that uses a mechanical oscillator layer used to cause vibration to occur in the carbon nanotubes with the attached magnetic bacteria

12. An electronic chipset as set forth in claim 1 that includes but is not limited to a single copper coil foil wire used to generate the voltage and current for self-powering electronics

13. An electronic chipset as set forth in claim 1 that includes, but is not limited to, multiple layers of copper coil foil wire used to generate the voltage and current for self-powering electronics

14. A self charging self-storage electronic chipset that produces its own power through Radio Frequency (RF) power harvesting that includes, but is not limited to, one Ni—Mn—Ga magnetoplastic crystal magnetic conductive crystal over which a carbon nanotube with magnetic bacteria have been attached which will resonate in the presence of RF fields causing voltage and current to be generated in the Ni—Mn—Ga magnetoplastic crystal with said power being stored on a layer of carbon nanotube storage media, which will be used to power the chip and or other chips.

15. An electronic chipset as set forth in claim 13 that contains a storage layer to include, but is not limited to, carbon nanotubes used to store the power generated by the RF field.

16. An electronic chipset as set forth in claim 13 which uses any type of resonating material which will vibrate at specific frequencies. The material could include but not limited to quartz crystals, mica crystals, stainless steel spring wire, or carbon steel spring wire.

17. An electronic chipset as set forth in claim 13 that contains a storage layer to include, but is not limited to, carbon nanotubes used to store the power generated by the RF field

18. An electronic chipset as set forth in claim 13 that contains a storage layer to include, but is not limited to, Bismuth Lanthanum Neodymium Titunate (BLNT) used to store the power generated by the RF field

19. A chipset as set forth in claim 13 which includes, but is not limited to, multiple lengths of carbon nanotube generators with attached magnetosomes used to take advantage of multiple frequencies

20. An electronic chipset the includes silicone pillars as set forth in claim 13 with an attached electrical conductive coil mesh.
